(19) United States
(12) Patent Application Publication
(10) Pub. No.: US 2007/0226455 A1
(43) Pub. Date: Sep. 27, 2007

(54) Variable clocked heterogeneous serial array processor

(76) Inventor: Laurence Hager Cooke, Los Gatos, CA (US)

Correspondence Address: Laurence H. Cooke, 565 San Benito Ave., Los Gatos, CA, 95030, US

(21) Appl. No.: 11/374,790

(22) Filed: Mar. 13, 2006

(51) Int. Cl. G06F 15/00

(52) U.S. Cl. 712/10

(57) ABSTRACT

A serial array processor, whose execution unit, which s comprised of a multiplicity of single bit arithmetic logic units (ALUs), performs parallel operations on a subset of all the words in memory by serially accessing and processing them, one bit at a time, while the instruction unit is pre-fetching the next instruction, a word at a time, in a manner orthogonal to the execution unit, is presented. This architecture utilizes combinations of masked address decodes to program registers which control the routing of data from memory, to the ALUs and back to memory. In addition the processor has extensions for calculating or measuring and adjusting the execution unit's clock to match the time required to execute each serial clock cycle of any particular operation, as well as techniques specific to this architecture for preprocessing multiple instructions following a branch, to provide a “branch look-ahead” capability.

### FIELD OF THE INVENTION

The present invention pertains to single instruction, multiple data processors, serial processing, re-configurable processing, orthogonal memory structures, and self-timed logic.

### BACKGROUND OF THE INVENTION

Numerous examples of single instruction, single data path processors exist. Intel, MIPS, ARM and IBM all produce well-known versions of these types of processors. In recent years, in the continuing push for higher performance, these standard processors have grown to include multiple execution units with individual copies of the registers and out-of-order instruction processing to maximize the use of the multiple execution units. In addition, many of these processors have increased the depth of their instruction pipelines. As a result, most the execution units become underutilized when the processing becomes serialized by load stalls or branches. In addition, much of the computational capability of these execution units, which have grown from 16 to 32 and on up to 64 bits per word, is wasted when the required precision of the computation is significantly less than the size of the words processed.

On the other hand, array processor architectures also exist. Cray, CDC and later SGI all produced notable versions of these types of computers. They consist of a single instruction unit and multiple execution units that all perform the same series of functions according to the instructions. While they are much larger than single instruction, single execution processors, they can also perform many more operations per second as long as the algorithms applied to them are highly parallel, but their execution is highly homogeneous, in that all the execution units perform the same task, with the same limited data flow options.

On the other side of the computing spectrum there exist re-configurable compute engines such as described in U.S. Pat. No. 5,970,254, granted Oct. 19, 1999 to Cooke, Phillips, and Wong. This architecture is standard single instruction, single execution unit processing mixed with Field Programmable Gate Array (FPGA) routing structures that interconnect one or more Arithmetic Logic Units (ALUs) together, which allow for a nearly infinite variety of data path structures to speed up the inner loop computation. Unfortunately the highly variable, heterogeneous nature of the programmable routing structure requires a large amount of uncompressed data to be loaded into the device when changes to the data path are needed. So while they are faster than traditional processors the large data requirements for their routing structures limit their usefulness.

This disclosure presents a new processor architecture, which takes a fundamentally different approach to minimize the amount of logic required while maximizing the parallel nature of most computation, resulting in a small processor with high computational capabilities.

### SUMMARY OF THE INVENTION

Serial computation has all of the advantages that these parallel data processing architectures lack. It takes very few gates, and only needs to process for as many cycles as the precision of the data requires. For example FIG. 1 shows the logic for a serial one-bit adder 10. It can require as little as 29 CMOS transistors to implement. It takes only N+1 clock cycles to generate a sum 12, least order bit first, of the two N bit numbers 11, also least order bit first. As shown in FIG. 2, multiple copies 20 may be strung together to produce a multiplier, which, when preloaded with the multiplier 21, serially produces the product 22 of the serially inputted multiplicand 23 in 2N+1 cycles, also least order bit first.

Even smaller structures may be created to serially compare two numbers as shown in FIG. 3, or swap two numbers as shown in FIG. 4. As such, all of these functions and logic operations such as AND, OR, NOT and XOR (exclusive or) may be combined into a compact serial Arithmetic Logic Unit (ALU) 53 such as shown in FIG. 5, and easily replicated into an array processor's execution unit.

This disclosure describes a way to simultaneously address and route multiple words of data to multiple copies of such serial ALUs by accessing multiple words of data one bit at a time, and serially stepping through the computation for as many bits as the precision of the computation requires. The instructions are accessed out of a two-port memory, one word at a time, which is orthogonal and simultaneous to the data being accessing. The serial computation takes multiple clock cycles to complete, which is sufficient time to serially access and serially generate all the addresses necessary for the next computation.

Furthermore, a dynamically re-configurable option is also presented which increases the flexibility of the processing while minimizing the amount of configuration data that needs to be loaded.

In addition, options are presented to selectively separate or combine the instruction memory from the data memory thereby doubling the density of the available memory, while providing communication between the instruction unit and the execution unit to do the necessary address calculations for subsequent processing.

The capability to logically combine multiple masked decodes gives the instruction unit the ability to route data from memory to the ALUs and back to the memory with complete flexibility.

A look-ahead option is also presented to select between one of a number of sets of masked decoded address data thereby eliminating the delay when processing one or more conditional branches. Unlike deeper pipelined processors, such an option is sufficient, providing the next instructions in both the branch and non-branch cases are not branches.

Lastly, because of the configurable nature of the serial data paths, resulting in a wide variation in the time required to execute a cycle of an instruction, a timing structure and a variety of instruction timing techniques are presented to minimize the execution time of each instruction.

### BRIEF DESCRIPTION OF THE DRAWINGS

The invention will now be described in connection with the attached drawings, in which:

FIG. 1 is a diagram of a single bit serial adder,

FIG. 2 is a diagram of a single bit serial multiplier,

FIG. 3 is a diagram of a serial compare,

FIG. 4 is a diagram of a serial swap,

FIG. 5 is a diagram of a single bit ALU,

FIG. 6 is a diagram of the array processor's execution unit,

FIGS. 7a, 7b and 7c are detailed diagrams of the address registers,

FIG. 8 is a diagram of the array processor's instruction unit,

FIGS. 9a and 9b are diagrams of decoders,

FIGS. 10a, 10b and 10c are diagrams of two port orthogonal memory cells,

FIGS. 11a and 11b are diagrams of configurable execution units,

FIG. 12 is a diagram of the use of a two port orthogonal memory,

FIG. 13 is a diagram of an array add operation,

FIG. 14 is a diagram of an array compare and swap operations,

FIG. 15 is another diagram of compare and swap operations,

FIG. 16 is a diagram of a multiply operation,

FIG. 17 is a diagram of combinatorial logic for the addresses,

FIG. 18 is a diagram of look-ahead storage for the address registers,

FIG. 19 is a diagram of the execution unit with timing check logic, and

FIG. 20 is a diagram of the timing check logic.

### DESCRIPTION OF VARIOUS EMBODIMENTS

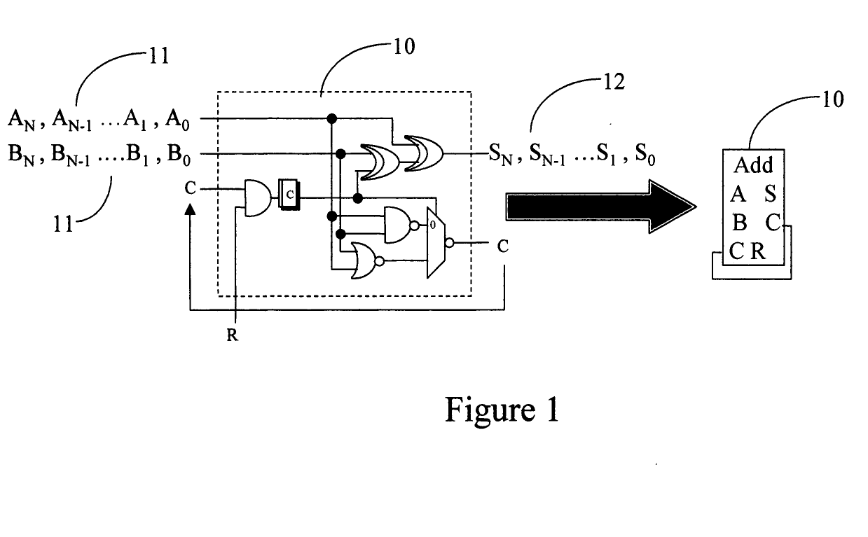

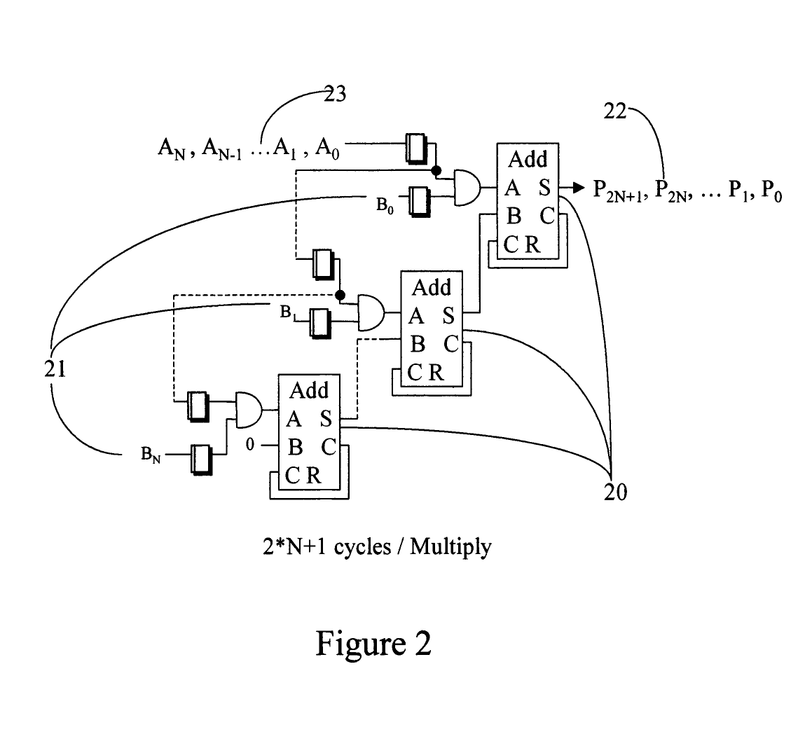

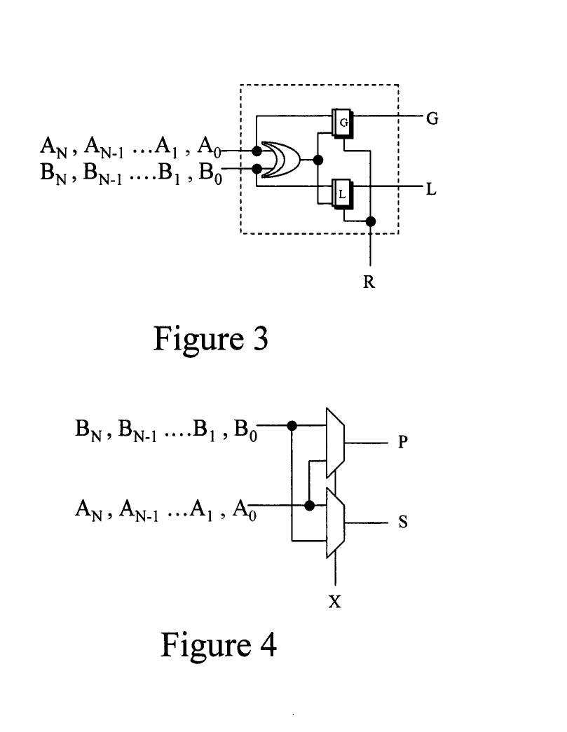

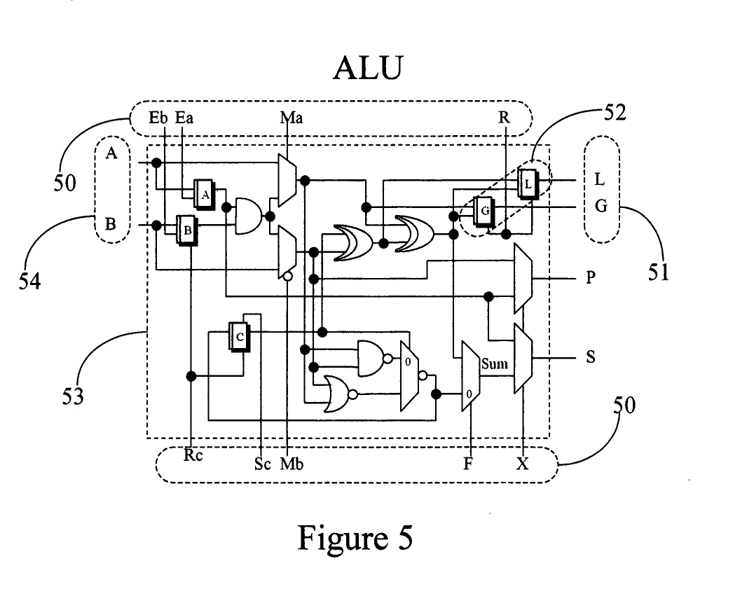

The present invention is now described with reference to FIGS. 1-12, it being appreciated that the figures illustrate the subjects matter and may not be to scale or to measure.

A preferred embodiment of the present invention is a single instruction multiple data execution array processor which utilizes a two port orthogonal memory to simultaneously access instruction words and their associated addresses in a serial fashion while serially processing data, one bit at a time through an array of execution units.

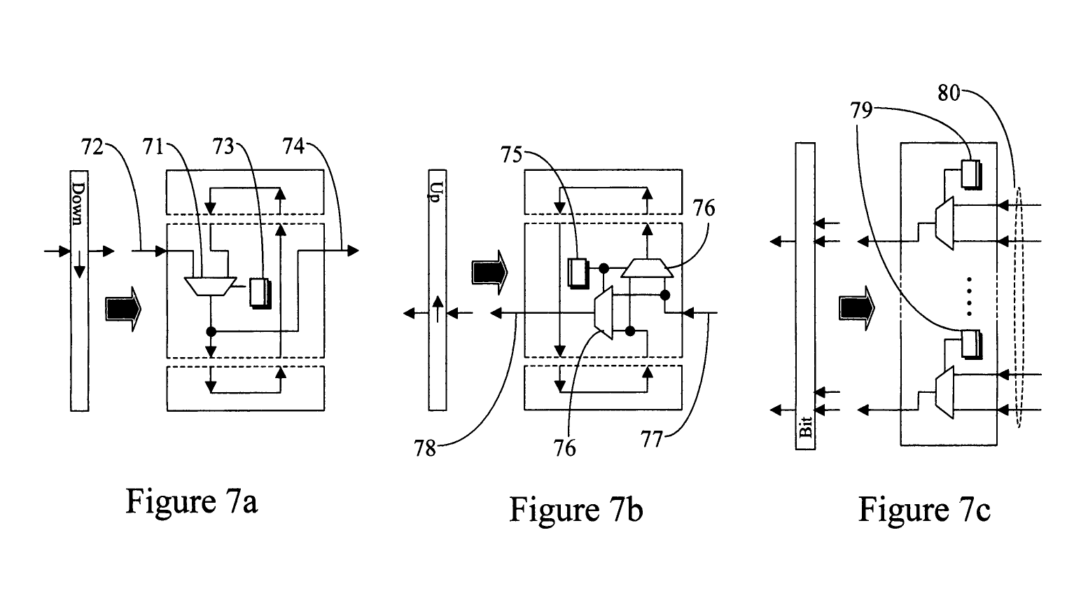

Reference is now made to FIG. 6, a diagram of the memory and the execution unit of the serial array processor. The orthogonal memory 55 has two modes of accessing data; a word at a time by applying an address to a traditional decoder 56, which reads or writes all the bits 57 of a selected word address 58 in parallel, or a bit of every word at a time by a circular shift register 59 selecting a bit 60 out of each word the memory 55 to read or write. All the bits are selected in successive clock cycles in order from the least order bit to the highest order bit by shifting the circular shift register 59. In the configuration shown in FIG. 6, each bit is selected by 8 address registers 61-64 to be routed either back to the memory 55 or through an ALU 66, which is set up to perform a specific function through the control logic 65. Two address registers 61, labeled down, select the bits 60 outputted from the memory 55 to propagate down through their circular string of multiplexors. Two other address registers 63, labeled up, select bits to either pass through or propagate up through their multiplexors. Another two address registers 62, select between the propagated bits in the four address registers 61 and 63, to either transfer them directly into the set of up address registers 63, or put them into an ALU 66, in which case the ALU's 66 outputs are put into the up address registers 63. The last two address registers 64 select between the bits propagated on the up address registers 63 and the original contents of the memory, to be written back into the addressed bits 60 in the memory 55.

Any number of ALUs 66 may be present up to one ALU 66 per word address. Each ALU 66 receives data either from two successive addresses in memory 55 or from the down address registers 61, and outputs their results to each of the up address registers 63. With this structure any number of words in memory 55 may be accessed in parallel, transferring each bit of each word to the nearest ALU below the accessed word, and propagating the output from each ALU to any ALU or memory address above it. An extra bit 67 exists on the circular shift register 59 to set the ALU control logic 65 at the beginning of each serial operation.

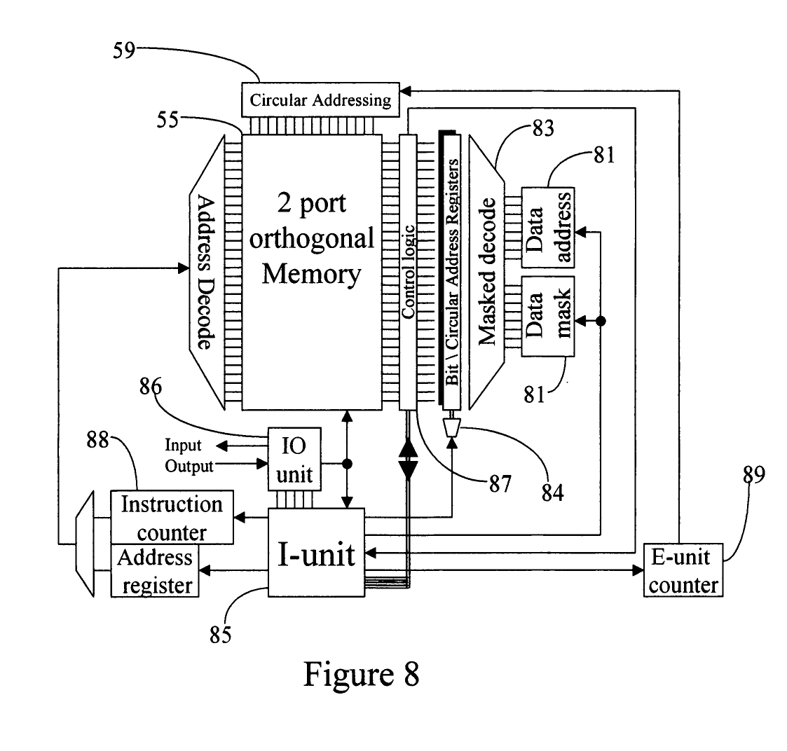

Reference is now made to FIGS. 7a through 7c, the detailed diagrams of the address registers in FIG. 6. Each of these registers has at least one latch per word outputted from the memory, which is used to control the selection of the bit of data at that address. The diagram in FIG. 7a shows one bit and the ends of a down address register. Each latch 70 controls a multiplexor 71, which either selects the inputted bit 72 to propagate down, or continues the propagation of a bit 73 from an address above it. The last selected bit is available on the output 74 of each address location. The diagram in FIG. 7b shows the two ends and a bit of an up address register. In this case the latch 75 controls two multiplexors 76, which either make the inputted bit 77 available on the output 78, passing over the propagated bit, or output the propagated bit and begin propagating the inputted bit. The diagram in FIG. 7c shows two bits of the address registers 62 and 64, in FIG. 6. The latch 79 selects between two inputted bits 80 for each address.

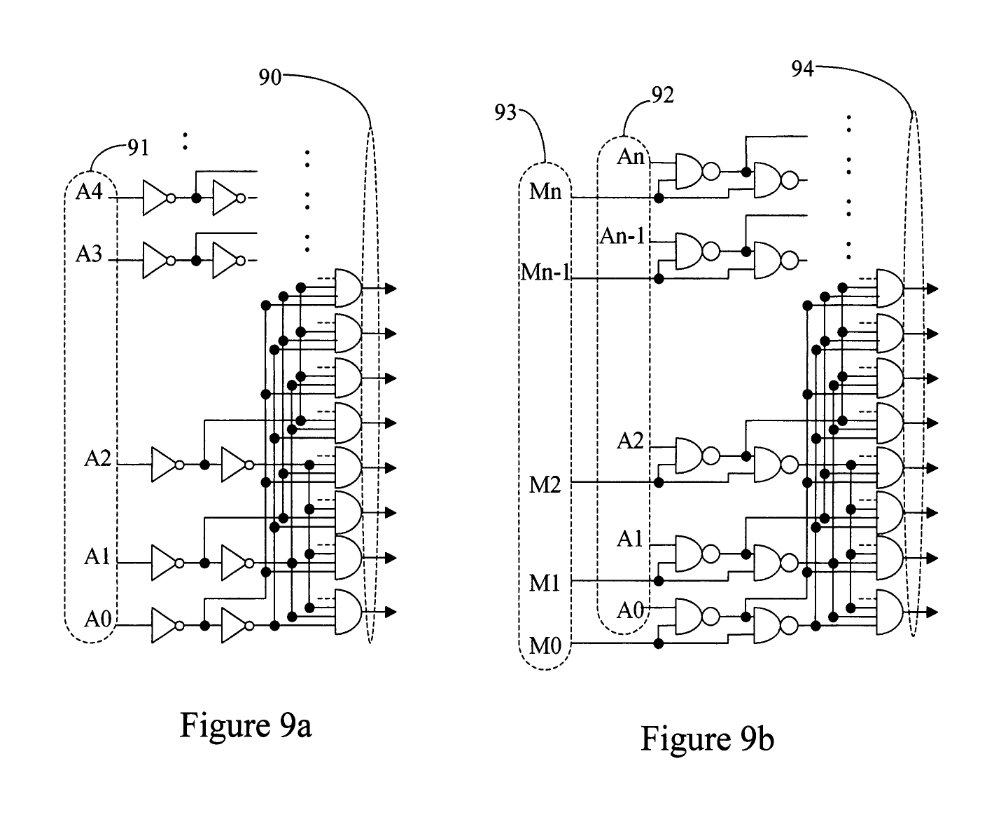

Reference is now made to FIG. 8, a diagram of the instruction unit controls for the serial array processor. Instructions are read from memory by addressing memory 55 with the instruction counter 88. The instructions contain relative references to the Address and Mask data, which are read and placed into the data Address and data mask registers 81, are decoded by a special data decode 82 and stored in the appropriate address register 83, selected 84 by the I-unit 85, on up to 8 successive clock cycles. Input and Output is written or read into the memory 55 by the I/O unit 86 either directly in parallel, or serially through the control logic 87. For less than full word computation, the E-unit counter 89 may be set by the I-unit 85, such that it resets the circular shift address register 59, prior to it completing a cycle of addressing.

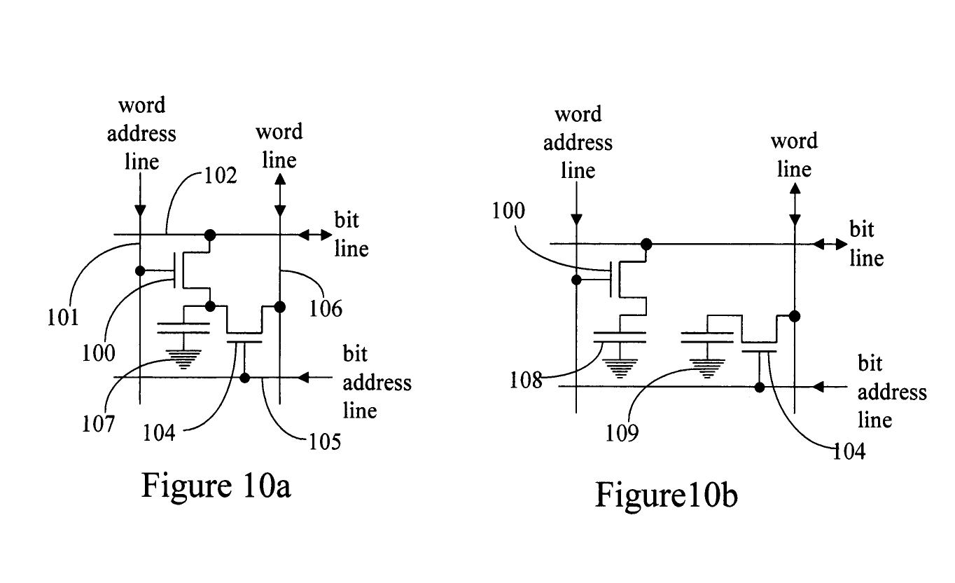

Reference is now made to FIGS. 9a and 9b, diagrams of address decoders. FIG. 9a shows a traditional address decoder, such as 56 shown in FIG. 8. It sets one of its outputs 90 high and the rest low for any specific combination of inputs 91. By contrast, FIG. 9b is a diagram of the masked decode 82 shown in FIG. 8. It contains both address inputs 92 and mask inputs 93, and sets all outputs 94 high whose addresses are equivalent to the address inputs 92 when both are ANDed with the compliment of the mask inputs 93. In this fashion blocks of addresses may be selected to set up multiple serial operations to execute in parallel.

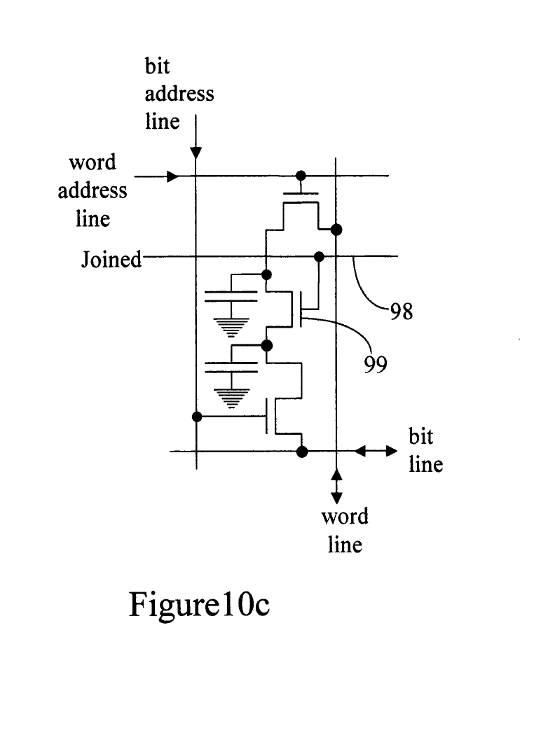

Reference is now made to FIGS. 10a, 10b and 10c, diagrams of possible constructions of the memory cells in the two port orthogonal memory 55 shown in FIG. 6. FIG. 10a shows a DRAM (dynamic random access memory) structure, where one transistor 100 is selected by the appropriate word address line 101 to read or write all the bits in a word on bit lines 102, while perpendicular to the first, a second transistor 104 is selected by the appropriate bit address line 105 to read or write a single bit in all the words on their word lines 106. In this case both transistors 101 and 104 access the same grounded capacitor 106. This allows simultaneous access of both program instructions and data in a fashion most appropriate for their processing, and in spite of its small size, it is almost twice as large as a single bit of DRAM. While some amount of overlapping memory is appropriate so the execution units can create addresses and masks for subsequent instructions, this overlap may be limited to a predefined set of address locations, and all other memory cells may be structured such as shown in FIG. 10b, where each transistor reads and writes its own capacitor 108 and 109, such that they appear to be two completely separate memories for that set of words. In this fashion the two-port orthogonal memory may contain separate program and data in one block of words and combined program/data values in another block of words. The size of the combined block of words may then be limited to the memory that must be used by both the I-unit and the execution units thus minimizing the memory overhead of such communication.

Unfortunately, the amount of combined memory may not always be well defined enough to create a two port orthogonal memory with fixed blocks of combined and separate memory structures, but with the addition of a single transistor 98 between the other two transistors 100 and 104, which joins the two cells together when the joined 98 word line is high, acts as a dynamic separate or combined memory cell. A separate address register, configured by an address and mask such as loaded into the masked decode 82 shown in FIG. 8 may be used to set the joined 98 word lines over the necessary block of words for any particular application.

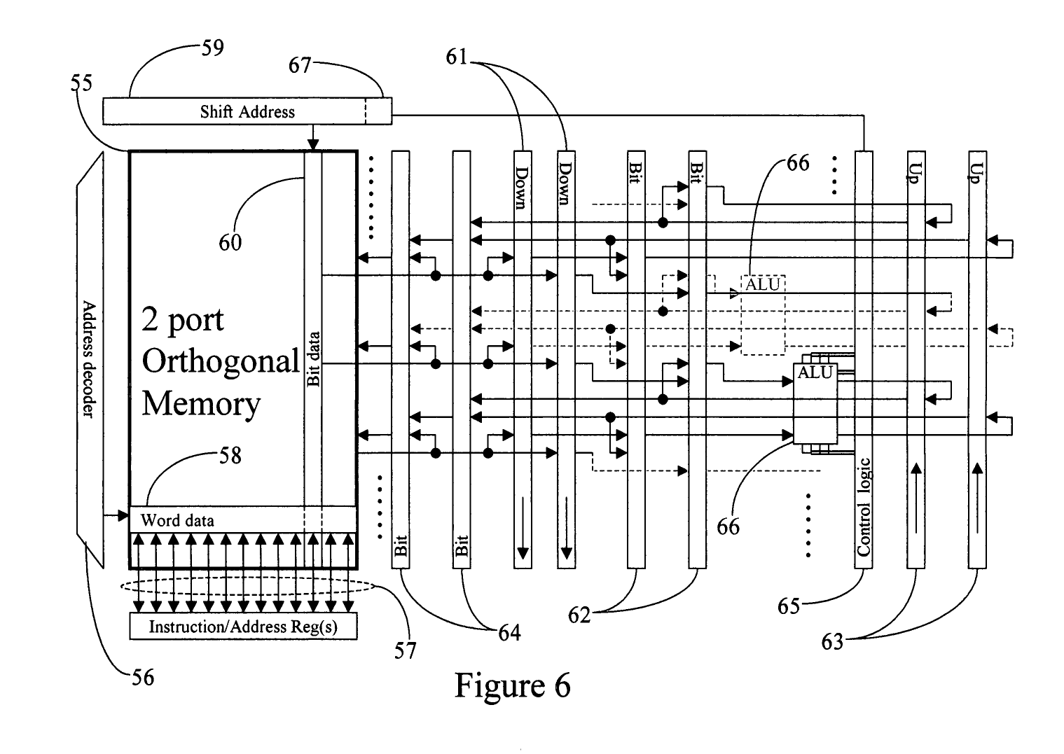

Reference is again made to FIG. 5, a diagram of an ALU 53. In order to perform one of a number of different functions, some of which are shown in FIGS. 1 through 4, it is necessary to set or clear a number of control inputs 50 at various cycles throughout the execution. Typically these are driven by the I-Unit 85 through the control logic 87 shown in FIG. 8. Similarly, the control outputs 51, typically the results of a comparison, are captured by the control logic and also used to control the inputs 54 of subsequent operations such as the swap operation. For versions of the serial array processor that contain a large number of ALUs 53, this translation can be either a large amount of logic or a large amount of wiring. Furthermore to allow each of the ALUs to perform a different function, each ALU 53 must be separately addressed for each possible function. This would require many more sets of address registers such as seen in FIGS. 7a, 7b or 7c.

In another embodiment of the present invention, the Arithmetic Logic Units may be configurable, and configured prior to each operation from data residing in a separate memory or within the two-port orthogonal memory.

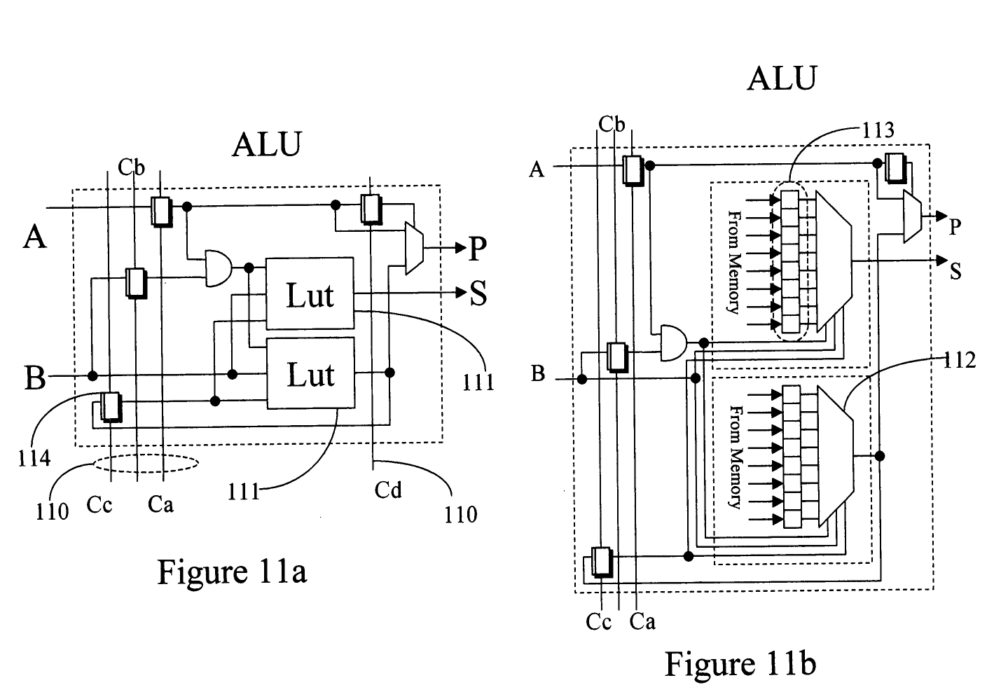

Reference is now made to FIGS. 11a and 11b, diagrams of a configurable ALU. In this case the control logic is limited to three clocks or clock enable lines 110 which either capture, hold or propagate input values to the two three input look-up tables 111 in the ALU. Look up table 111 further consists of a 3 to 8 select 112 and eight storage elements 113, which may be loaded from memory to perform a variety of different functions.

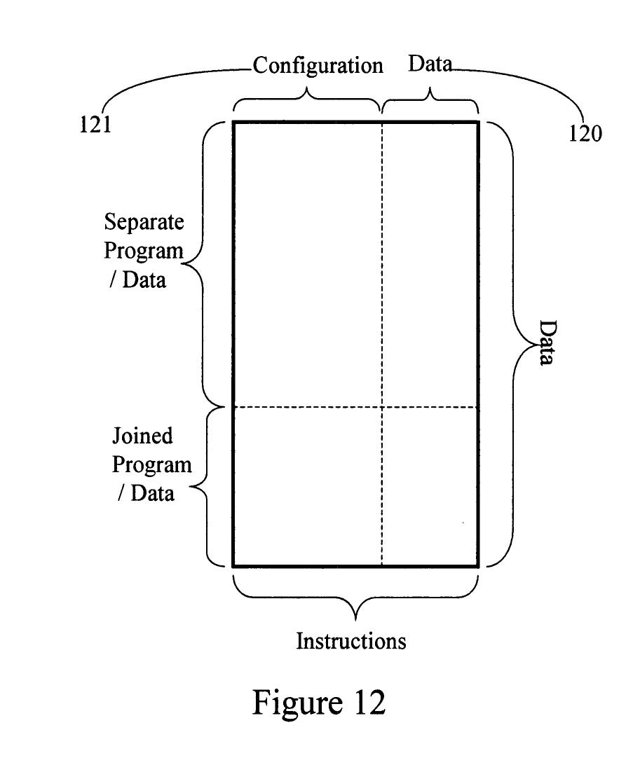

Reference is now made to FIG. 12, a diagram of one memory configuration. In this configuration, the data 120 does only fills part of each word of memory. The rest of each word may be filled with look-up table configuration information 121. In the set of possible configurations of the array processor where there are at most one ALU for every 16 words of memory, every 16 bits out of a column of bits in the two port orthogonal memory may be loaded into one configurable ALU such that all ALUs may be configured during the clock cycle when no data is addressed. Alternatively, the configuration information may reside in a separate memory, or one or more configurations of memory may reside in a word of memory which is loaded into the ALUs addressed in the same fashion as the address registers 83 in FIG. 8 are addressed.

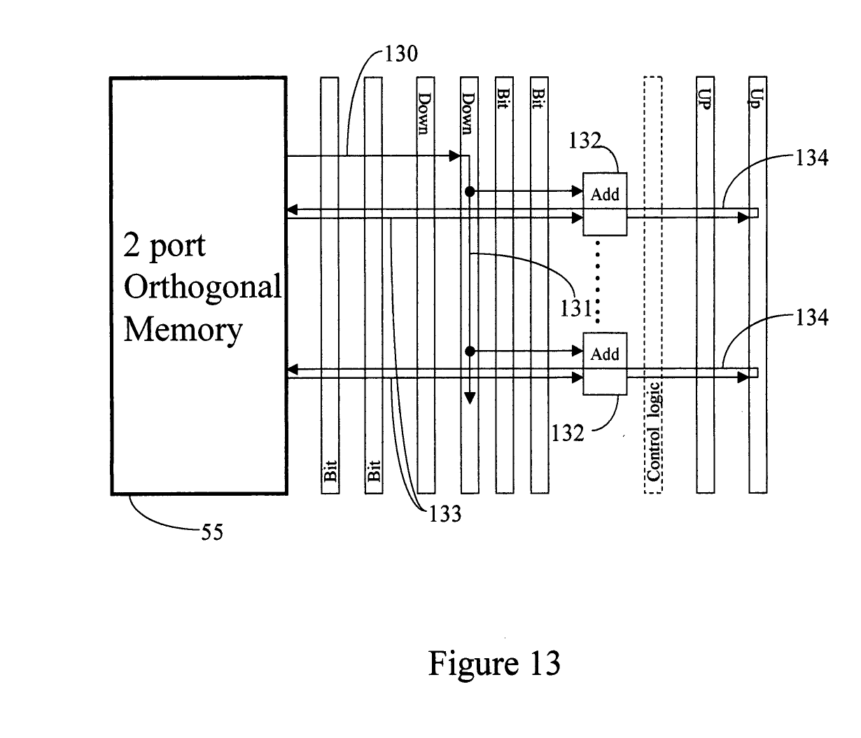

Reference is now made to FIG. 13, an example of adding a value to an array of values. An output 130 of the memory 55 is propagated down 131 and is inputted into each of the ALUs 132 in the array. The word 133 at each ALU 132 location is also inputted into that ALU. The sum of the two inputted bits is outputted 134 back into the memory 55, replacing the outputted value. In this fashion a single value may be simultaneously added to M values in an array. A traditional processor would take around K*M cycles where K is between 2 and 5 instructions per Addition, and M is the number of elements in the array. In this processor it only takes N+1 cycles where N is the number of bits in the words being added. As such this array processor is much faster than a traditional processor when M is larger than N.

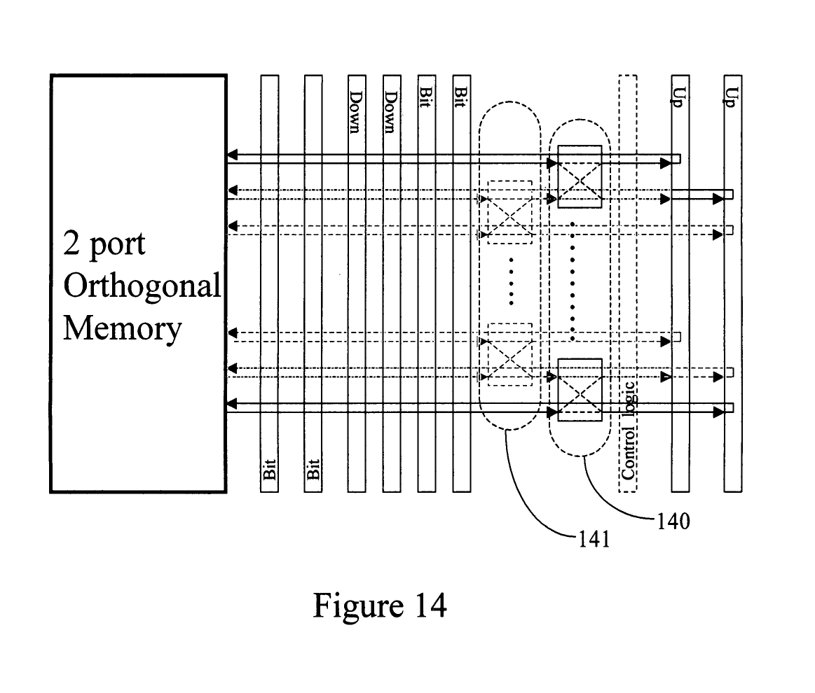

Reference is now made to FIG. 14, an example of compare and swap operations on an array. These instructions are used to sort an array of values. The first compare selects every word in the array to be compared by half the ALUs 140 in the execution unit. After N cycles the latches 52 in FIG. 5 indicate which word is larger. In the next swap instruction the state of these latches are used to either put each word back where it came from or swap them. This also takes N cycles. In order to properly sort the array, the next compare and swap uses the other half of the ALUs 141. In this fashion, by repeating these compare and swap operations such that M swaps have taken place, an array of M values may be sorted. The number of cycles to accomplish this is 2M*(N+1). By comparison the fastest sort in a traditional processor is on the order of K*M² log₂ M, clearly much slower even when M=N. On the other hand it requires the existence of one ALU per word of memory.

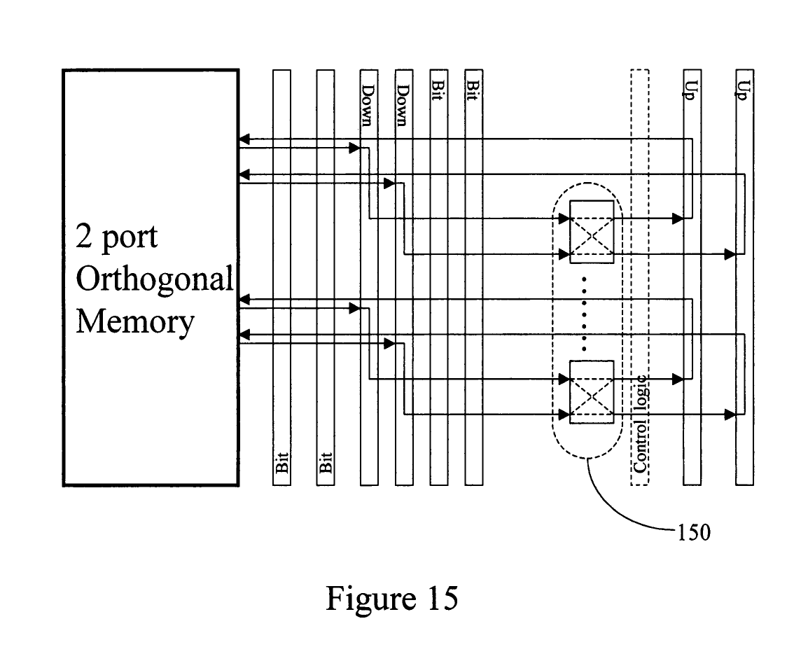

Reference is now made to FIG. 15, compare and swap operations using I ALUs. In this case only I ALUs 150 exist in the execution unit. To sort an array of M values each pair of values must be selected from memory and propagated down to the inputs of the compare, and the results of the subsequent swap must be put back in the pair addresses where they came from. To access all the M values in an array once will require M/2I such compare and swap operations, selecting a new pair of addresses on each compare and swap. As such it would then take M² (N+1)/I cycles to complete the sort, which, though still faster, clearly approaches (and can exceed) K*M² log₂ M cycles as I, the number of ALUs is reduced towards 1.

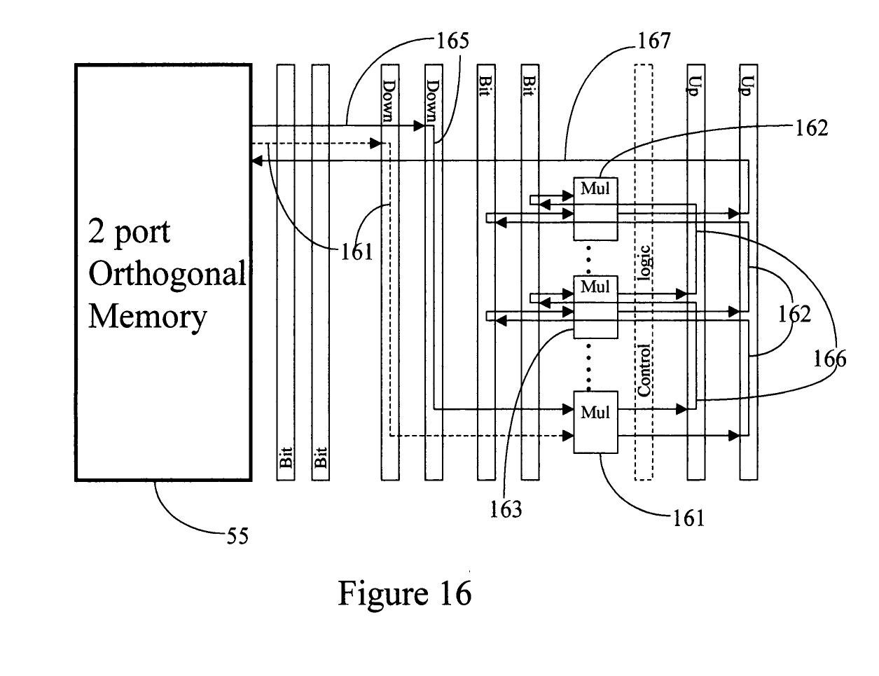

Reference is now made to FIG. 16, an example of a multiply instruction. In this case, during the first N+1 cycles a path is selected 160 for the multiplier to be loaded into the first ALU 161 and through the sum path 162 to the rest of the ALUs 163 and 164. In the next 2N+1 cycles a path for the multiplicand is selected 165 such that on each successive clock cycle the bits of the multiplicand are shifted through the first ALU 161 and through the second path 166 to the rest of the ALUs 163 and 164. A path 167 is also selected during these 2N+1 cycles to output the product from the last ALU 162 back into the memory 55. Clearly it takes N ALUs to produce a 2N bit product. If there are only N bits in the multiplicand zeros must be inserted into the multiplicand path 165 for the last N+1 cycles of the multiply. In this fashion it is clear that it would take 3N+2 clock cycles to complete J multiplies in parallel, where J*N is less than or equal to the number of ALUs in the execution unit.

In each of the above examples it should be noted that some paths are much longer than others. For example the path 130 in FIG. 13 may span a large number of addresses, and path 166 in FIG. 16 spans a large number of ALUs when N is large. By contrast the paths in FIG. 14 are quite short. In a traditional synchronous processor the clock cycle must be fixed to ensure signal propagation through the longest single cycle path while ensuring at least one clock cycle's delay through multi-cycle paths. In this processor the longest possible path may be many times the delay of the shortest path, which would make a fixed clock cycle particularly wasteful on short path executions.

In another embodiment of the present invention the clocks of the processor may be derived from a counter controlled by an oscillator, an inverting circular delay line, whose frequency adjusts to compensate for the process, temperature and voltage variations of the processor. The execution path of each instruction may then be calculated or measured to determine the proper setting for the counter so that the clocks only provide as much time as needed to complete the operations.

To calculate the counts, a delay model of the execution unit within the compiler. Using nominal process, voltage and temperature, the model is then used to simulate each compiled instruction and generate a for clocking the execution unit. These counts are loaded into the execution unit counter 89 in FIG. 8, at the beginning of each instruction.

Alternatively a measurement of the actual execution unit's delay may be performed after it is set up for an operation but prior to the execution of the operation, which is then used to set the execution unit's counter.

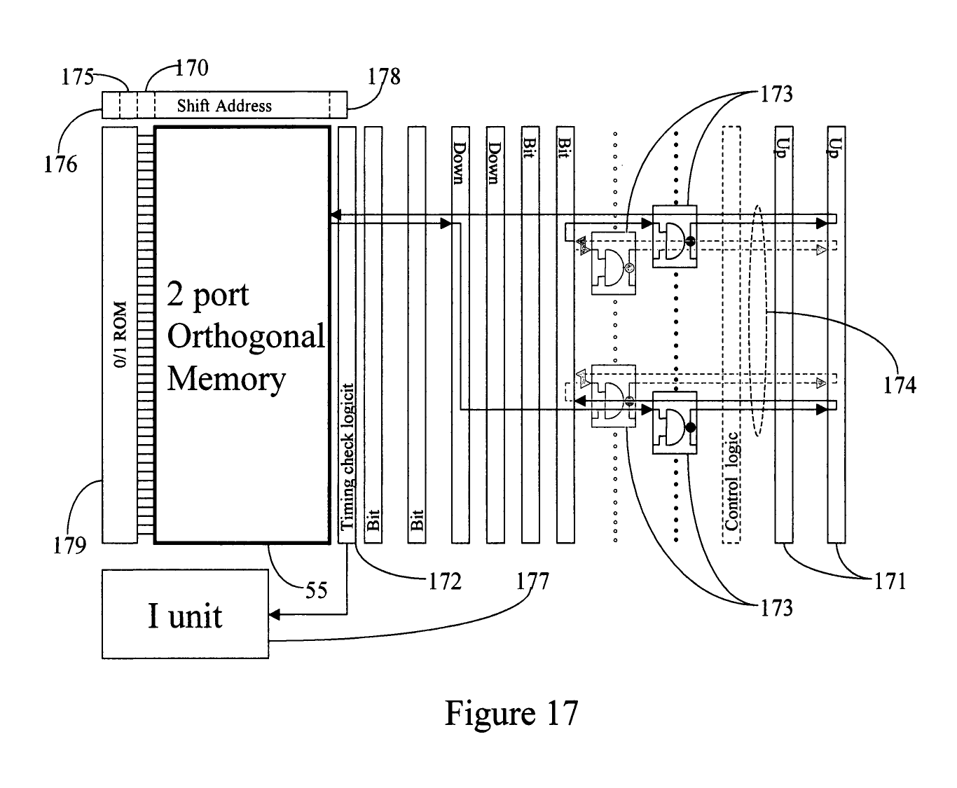

Reference is now made to FIG. 17, an example of an execution unit with timing check logic. At the completion of executing an operation, the circular shift register's reset bit 170 is set, at which time the address registers 171 are set with the new operation's paths. For an execution unit with timing check logic 172, the ALUs 173 are configured as AND functions of all the inputs to all the outputs. The next cycle of the circular shift register 175 loads 0s from the 0/1 ROM 179 into all the selected paths. On this clock cycle, the maximum clock is used from the digitally controlled oscillator. This guarantees that all lines are set to 0. The next cycle of the circular shift register 176 selects all 1s from the 0/1 ROM 179, which propagate through the paths 174 and ALUs 173, and back to the memory 55. Prior to entering the memory the positive transition is detected by the timing check logic 172, which is sent to the I unit 177, and used to generate the count for the digitally controlled oscillator. On the next cycle a second reset bit 178 of the circular shift register is selected and the ALUs are changed to their correct functions to begin the next serial operation.

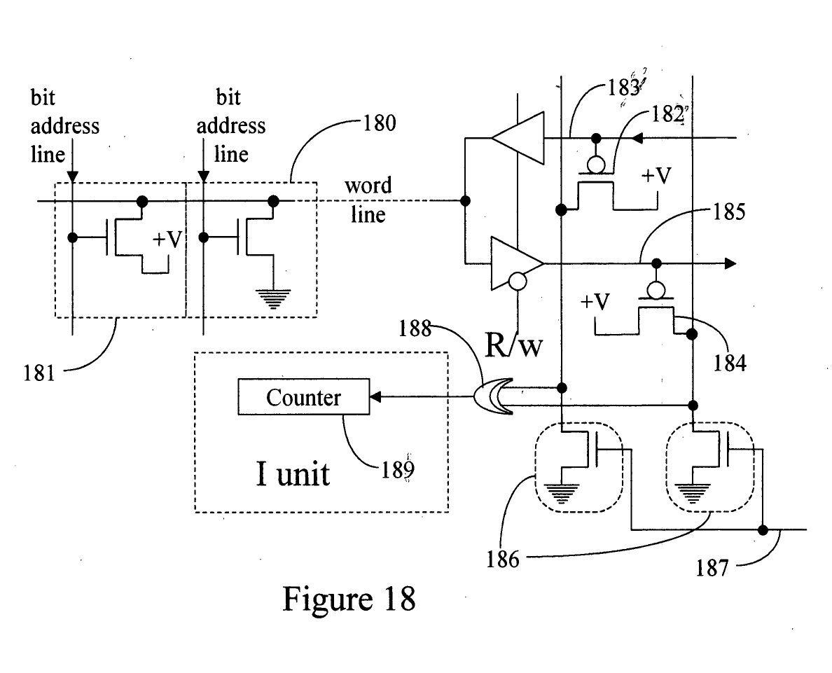

Reference is now made to FIG. 18, the details of a bit of the timing check and ROM. Each ROM word consists of a zero bit 180 followed by a one bit 181. The timing check logic consists of a strings of P-channel transistors 183 tied to the memory inputs 184, and a string of P-channel transistors 184 tied to the memory outputs 185, which are tied down by N-channel transistors 186 when their gates lines 187 are enabled. This propagates two 1s into the exclusive or (XOR) gate 188 which disables the counter 189 until all the memory outputs 185 transition high after which the counter is enabled until the inputs 183 all transition high and two 0s on the XOR gate 188 inputs disable the counter 189. At the end of this clock cycle the counter 189, which was driven by the same oscillator that clocks the execution unit's counter, contains the count for the Read cycle of the execution unit's operation. On the next cycle, and every cycle of the operation thereafter, the counter's 189 contents is loaded into the execution unit's counter.

It is further contemplated that separate timing check logic, and separate counters, may be used to time the clocks for the ALU latches such as shown in FIGS. 5 and 11a. These counters would be enabled by transistors 184, but disabled by their own version of transistors 182.

In yet another embodiment of the present invention logic may be included in the Masked decoder to allow for logical operations on multiple masked addresses prior to loading the address registers.

Reference is again made to FIG. 9b, the detailed logic of a masked decode. The masked decode logic allows groups of outputs 94 with the same bits of an address 92 that are not masked by the mask bits 93 to be selected. For example the 8 bit address 10011011 and 8 bit mask 00110001 selects all bits whose address matches 10xx1101x, where the x bits may be either 1 or 0. This type of decode makes it easy to select all the addresses in a contiguous group whose size is a power of 2 and begins on an address that is an even multiple of that size. For example the masked 8 bit address 0111xxxx selects all 16 words from address number 112 through number 127, where 112=7*16. Unfortunately this type of decode will not address a contiguous array that is neither a multiple of 2 in size nor starts at an address that is an even multiple of that size. In order to select all the elements in a contiguous array of an odd size or starting on an odd boundary it is necessary to logically combine multiple masked addresses.

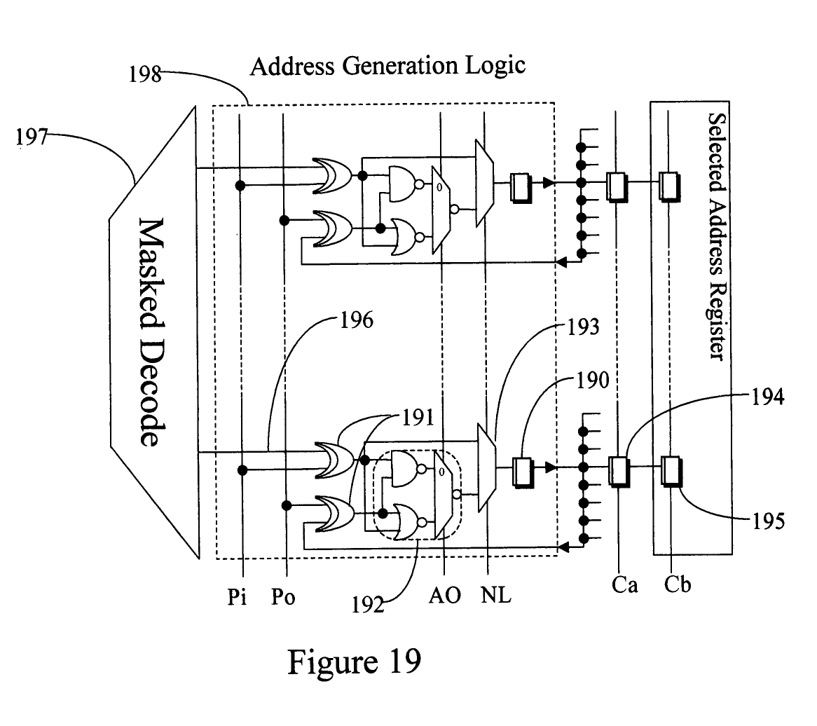

Reference is now made to FIG. 19, a diagram of additional address generation logic appended to a masked decode. Typically, without the additional address generation logic 198, each output 196 from the masked decode 197 fans out directly to a pre-stage latch 194 for each of the 8 address registers, that loads the latch 195 in the address register during the reset cycle. The additional address generation logic 198, for each bit, includes: a latch or flip-flop 190, for storing the intermediate results; two XOR gates 191 for controlling the polarity of the intermediate result and the next mask decoded address; logic 192 for selecting the AND or OR of the intermediate results and the next decoded address; and a multiplexor 193 to select either the mask decoded address or a function of the next mask decoded address and the intermediate results to become the next results. With this additional logic any contiguous, or non-contiguous, group(s) of selected addresses may be generated by logically combining two or more masked addresses. For example, a contiguous group of 27 words beginning at address number 113, may be generated from three 8 bit masked addresses as follows: 0111xxxx AND (NOT 011111xx) AND (NOT 01110000). In other words, starting with a contiguous group of 32 words beginning at address 112, and eliminating the 4 words beginning at address 124 and then eliminating the word at address 112, a contiguous group of 27 words beginning at address 113 remain.

In yet another embodiment of the present invention a compiler can construct any desired contiguous subset of N selected addresses out of 2^{M} possible addresses using 2*Int[log₂ N]−2 or less masked addresses by
a. bisecting the contiguous subset of N selected addresses into an upper and lower subgroup about the address with the largest even power of 2 and for each sub group,
b. selecting a masked address that produces a primary group of addresses with the least differences from the sub group, and
c. selecting the masked address, which produces the largest group addresses that is within the primary group and outside of the subgroup, and if such a group exists, excluding the group from the primary group,
d. selecting the masked address, which produces the largest group addresses that is within the sub group and outside the primary group, and if such a group exists, including the group in the primary group, and
e. repeating steps c and d until no groups exist.

To see how this works, first select the address to bisect the group of N addresses into a lower and upper group with the bisecting address included in the upper group. Masked address groups of any size up to N may be created about this bisecting address because a group of N elements where 2^{K}<=N must begin, cross or end on an address that is a multiple of 2^{K} since there are only 2^{K}−1 addresses between addresses that are multiples of 2^{K}. Now for the upper subgroup, any size contiguous group, whose size is a power of 2 up to 2^{K} can be created as was described above, and for the lower subgroup any group of size 2^{J}, where J<=K must begin on I*2^{K}2^{K}−2^{J}=I*2^{K-J}*2^{J}−2^{J=[I*}2^{K-J}−1]*2^{J}, which is a multiple of 2^{J}, and can also be created. By similar logic any subsequent smaller group that is added to or deleted from these two groups may also be generated.

Now since the group of N elements was bisected, the differences between the masked address groups and the subgroups must be less than 2^{K} where 2^{K}<N<=2^{K+1}, because the two groups combined would be at most be 2^{K+1} in size. Since the differences between the subgroups and masked address groups are contiguous groups and can be constructed by successively combining groups with 1 address to 2 addresses to 4 addresses, on up to 2^{K-1} addresses, which produces a group whose size is 2^{K}−1 addresses, any difference from 1 address to 2^{K}−1 addresses will be covered in K−1 masked addresses. In other words any contiguous group of N addresses, where N<=2^{K+1} (i.e. Int[log₂ N]=K+1) may be constructed with no more than 2+2(K−1) masked addresses.

As was mentioned before, the next instruction fetch and masked address decodes occur simultaneously with the serial computation. Since most computation will be between 16 and 32 bits in length, there are enough clock cycles to complete the masked address calculations described above, before the completion of the execution of the previous operation, unless the next instruction is a branch, which requires the results from the execution of the current instruction. For example, a sort may be terminated when the results of a compare such as described above, will result in no swapping of the compared values. The control logic 65 in FIG. 6 combines the results from the compare latches 52 in FIG. 5 for all the ALUs 66 in FIG. 6, to be used in a branch instruction to detect such a case. Unfortunately, the subsequent instruction must then be processed while no execution is occurring. On the other hand, in most cases there are enough clock cycles during the execution of the compare to process not only the next instruction but if it is a branch to also process both the instruction if the branch will be taken and the instruction if the branch will not be taken, but this branch look-ahead requires storing the preprocessed addresses for future instructions.

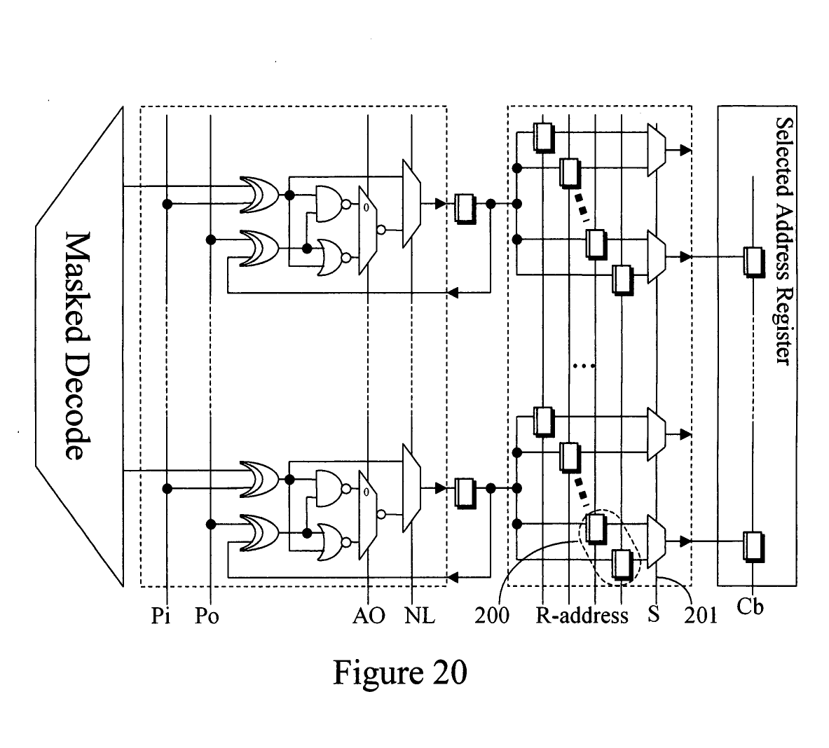

Reference is now made to FIG. 20, a diagram of the masked decode with additional temporary storage. In this case each bit has multiple independently addressed latches or flip-flops 200 for storing the intermediate results of any masked decode computation such as was described above. If 2 bits are available for each address, they may be filled with the generated masked addresses for two separate instructions. On a branch the Select input is controlled by the compare results from the control logic, thus selecting the set of values for the correct instruction following the branch to be loaded at the next reset cycle of the execution unit. In this way single branches can be made completely transparent. To make K levels of successive branches completely transparent would require selection between and loading 2^{K} latches, with a practical limit of K=log₂ N−3, where N is the number of bits in a normal word used in the execution unit.

Furthermore it is contemplated that more efficient logic or higher performance logic may be substituted for the detailed logic presented in this example of a serial array processor, and different types of memory cells, such as SRAM cells, PROM cells or a combination of both may be used in conjunction with the implementation of the 2 port orthogonal memory, or that two separate memories accessed in an orthogonal fashion may be used, where with the I/O unit reading and writing the data into the “data memory” for the execution unit in a serial fashion, while writing and reading the data into the “instruction memory” in a parallel fashion. It is also contemplated that such “data memory” and “instruction memory” may be cache memory, in which case the “data memory” is a 2 port orthogonal memory, with a parallel port to the external world, and the serial port connected to the execution unit. Other similar extensions to fit this serial array processor architecture into the environment of existing single instruction single data path processors is also contemplated.

It will be appreciated by persons skilled in the art that the present invention is not limited by what has been particularly shown and described hereinabove. Rather the scope of the present invention includes both combinations and subcombinations of various features described hereinabove as well as modifications and variations which would occur to persons skilled in the art upon reading the foregoing description and which are not in the prior art.

I claim:

1. A serial array processor including;
an instruction unit,
an execution unit comprised of a multiplicity of arithmetic logic units, and
at least one memory;
Wherein said instruction unit reads one multi-bit word from said at least one memory on each clock cycle, said multi-bit words comprising at least one instruction and processes said at least one instruction while said execution unit executes a prior one of said at least one instruction by;
reading a multiplicity of words, one bit from each of said multiplicity of words on each clock cycle, in multiple successive clock cycles from one of said at least one memory, serially processing said multiplicity of words, one bit on each clock cycle through at least one of said multiplicity of arithmetic logic units, and
storing the results in a multiplicity of words in one of said at least one memory.

2. A serial array processor as in claim 1 wherein said instruction unit and said execution unit read from the same one of said at least one memory.

3. A serial array processor as in claim 1 wherein at least one said execute follows a prior execute that includes at least one of:
reading from a different said multiplicity of words than said prior execute multiplicity of words,
processing through a different said multiplicity of arithmetic logic units than said prior execute multiplicity of arithmetic logic units, and
storing said results in a different said multiplicity of words than said prior execute multiplicity of words.

4. A serial array processor as in claim 1 wherein said multiplicity of words is addressed by selecting all words with addresses which match an inputted address when both addresses are masked with an inputted mask

5. A serial array processor as in claim 1 wherein said multiplicity of words is addressed by successively performing the intersection or union on all words with addresses which match an inputted address when both addresses are masked with an inputted mask, and all words previously selected.

6. A serial array processor as in claim 1 wherein said clock is generated from counter that is clocked by a process, temperature, and voltage-compensating oscillator.

7. A serial processor as in claim 6, wherein the count for said counter is generated by calculating the delay of the operation to be performed in the execution unit.

8. A serial array processor as in claim 6, wherein the count for said counter is derived by counting the number of clocks of said process, temperature, and voltage-compensating oscillator, that occur in the time it takes for a transition on all words in the memory read by said execution unit to propagate back to all words in said memory.

9. A serial array processor as in claim 8, wherein said arithmetic logic units are set to propagate said transition only when all inputs have completed said transition, and said transitions are captured in logic not used by said operation.

10. A serial array processor as in claim 1, wherein said at least one instruction is at least three instructions if the first of said at least one instruction is a branch, and subsequent to said execution unit completing the said prior one of at least one instruction then executes only one of the second or third of said at least three instructions as the next said prior one of at least one instruction.

11. A processor including;
an instruction unit,
an execution unit requiring at least four clock cycles to complete an operation, and
at least one memory;
wherein for each said operation, said execution unit;
on the first said clock cycle, reads a first level from said memory for all bits and configures logic units to propagate a transition on the transition of all said logic units inputs,
on the second said clock cycle reads a second level from said memory for all bit bits, said second level being different than said first level, captures said second level from all said memory outputs, captures said second level on all said memory inputs, and runs a counter from the capture of all said memory outputs to the capture of all said memory inputs, producing a count, and
on the third said clock cycle, uses said count to produce the clock for all subsequent clock cycles of the operation.

12. A processor as in claim 11 including;
a multiplicity of clocks each clocking a group of at least one storage element,
wherein said second clock cycle also captures said second level on all inputs of said storage elements, and runs a multiplicity of counters, one for each said group of storage elements, from the capture of said second level on all said memory outputs to the capture of said second level on all said inputs of said group of storage elements,
and said third cycle uses said counts to produce the clocks for each of said group of storage elements for all subsequent clock cycles of the operation.
